(19) United States
(12) Patent Application Publication
(10) Pub. No.: US 2012/0240494 A1
(43) Pub. Date: Sep. 27, 2012

(54) WINDOW CASING SYSTEM

(76) Inventors: KNUT SCHROEDER, San Jose, CA (US); Bryon M. Phillips, Los Gatos, CA (US)

(21) Appl. No.: 13/070,747

(22) Filed: Mar. 24, 2011

(51) Int. Cl. E06B 1/04

(52) U.S. Cl. 52/210; 52/745.15

(57) ABSTRACT

A window casing system includes a kit to completely finish the insides of windows in homes and offices. An installer provides key measurements of the window opening height, width, and depth, to the factory. Custom pre-finished jambs, casings, sills, and aprons are then packaged and delivered in a kit to the jobsite for installation. Plastic fasteners with ribbed shanks are included in the kit for the installer to press into holes and dados in the jambs, casings, and sill to permanently join them together. The top corner miters of the side and top casings are joined with unique, ribbed plastic corner elbows for tight, perfectly aligned joints. The whole is then either nailed, glued, or otherwise fastened into the window opening.

### BACKGROUND OF THE INVENTION

1. Field of the Invention

The present invention generally relates to building windows, and in particular to devices and methods for quickly and easily casing the insides of windows.

2. Description of the Prior Art

A typical window in a home or an office is dressed out with wood window casing to improve the looks and functionality. In the Victorian Era, window and door casings were elaborately designed and carved works of art that were installed and finished by artisans and craftsmen. In modern times, window casings, if installed at all, are simple and straightforward designs often cut on site from straight pieces of “one-by” lumber nailed up with finish nails and painted.

A universal lack of budget, skill, or even attention to detail often results in window casings that are not straight, not consistent, and show obvious gaps where the materials were not cut to the exact lengths or angles needed.

John L. Wetzel describes a window trim system in U.S. Pat. No. 4,811,533, issued Mar. 14, 1989. Wetzel describes a typical window casing that includes a horizontal wooden sill at the bottom that extends inside out past the wall and laterally beyond the left and right window opening edges. Inside the window opening there are two vertical side trim pieces that come out flush to the wall and a horizontal top trim piece that also comes out flush to the wall. A flat surround is built on the wall face joining the inside trim pieces and sill with a matching pair of left and right, and a top molding set back with some amount of “reveal” to add interest details.

Wetzel attempts to provide an adjustable width molding that “dramatically reduces the carpentry skill involved.” Summary. His other goals are to reduce manufacturing and installation costs, and to be able to accommodate dimensional differences in the depths of the window frames being encountered. Essentially a ring consisting of four trim pieces 22, 24, 26, and 28, have dadoes so they can telescope on matching rabbets on four corresponding main trim pieces, jambs 20, 23, 25, and 27. FIGS. 1-4. Such telescoping takes up any gap that would otherwise be revealed with window frame 12. The reveal left between the top and side wall-face casing pieces 15, 16, and 18 with side and head jambs 20, 25, and 27 is not controlled. The installer can easily get it wrong.

What is needed is an inexpensive window casing system that provides quick and easy installations that are consistent and professional appearing every time.

### SUMMARY OF THE INVENTION

Briefly, a window casing system embodiment of the present invention includes a kit to completely finish the insides of windows in homes and offices. An installer takes key measurements of the window opening height, width, and depth, and selects an appropriate standard unit or sends custom measurements to the factory. Pre-finished jambs, casings, sills, and aprons are then packaged and delivered in a kit to the jobsite for installation. Plastic fasteners with ribbed shanks are included in the kit for the installer to press into holes and dados in the jambs, casings, and sill. The top corner miters of the side and top casings are joined with unique, ribbed plastic corner elbows for tight, perfectly aligned joints. The whole is either nailed or glued into the window opening.

These and other objects and advantages of the present invention will no doubt become obvious to those of ordinary skill in the art after having read the following detailed description of the preferred embodiments that are illustrated in the various drawing figures.

### IN THE DRAWINGS

FIG. 1A is a perspective exploded assembly view of a window casing system embodiment of the present invention;

FIG. 1B is a perspective view of the window casing system of FIG. 1A after being assembled;

FIG. 2 is a perspective exploded assembly view of how the mitered ends of the casings are joined with H-connectors in a window casing system embodiment of the present invention;

FIG. 3 includes top, end, and side views of the H-connector of FIG. 2;

FIG. 4 is a perspective exploded assembly view of how the mitered ends of the casings are joined with L-connectors in a window casing system embodiment of the present invention;

FIG. 5 includes top and side views of the L-connectors of FIG. 4;

FIG. 6 is a perspective view of a zipper-tie embodiment of the present invention;

FIG. 7 is an end view of a zipper-tie connecting a window jamb to a casing, as in FIGS. 1A and 1B;

FIG. 8 is a flowchart of a method embodiment of the present invention for casing a window opening; and

FIG. 9 is a cross-sectional diagram of a second type of zipper tie in an embodiment of the present invention similar to that shown in FIGS. 1A, 6, and 7.

### DETAILED DESCRIPTION OF THE PREFERRED EMBODIMENTS

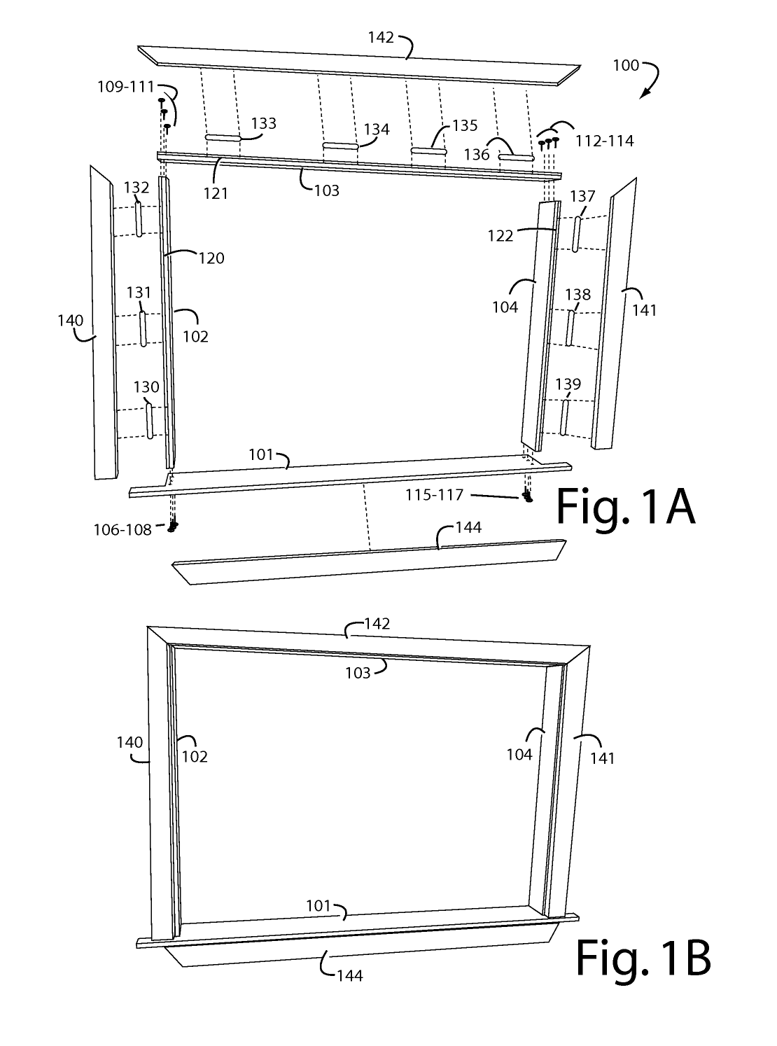

FIGS. 1A and 1B represent a window casing system embodiment of the present invention, and is referred to herein by the general reference numeral 100. A typical window casing system arrives on a jobsite as a ready-to-install kit 100 that comprises a sill 101, left jamb 102 a header or top jamb 103, and a right jamb 104 are all pre-measured and pre-cut at a factory to fit a particular window opening. In most cases of new construction, the installer is not required to do any cutting of the pieces on the jobsite to complete the installation.

The width of sill 101 and jambs 102-104 are ripped at the factory to fit snuggly up against a window frame that protrudes into the window opening at the outdoors side. Therefore, good measurements are essential and particular kits 100 need to be matched up on the jobsite with their corresponding window openings.

The sill 101 and jambs 102-104 are assembled together by the installer before being placed in their respective window openings using plastic ribbed-shank push-in fasteners 106-117. For example, using ITW Fastex (Des Plaines, Ill.) PINE-TREE™ or CHRISTMAS-TREE™ clips. These are inserted by the installer through matching, corresponding holes drilled into sill 101 and jambs 102-104. Assembly can be made a bit easier if the holes drilled through sill 101 and header jamb 103 are a bit larger in diameter than the blind holes drilled into the ends of each of the left and right jambs 102 and 104.

This subassembly can then be inserted and tacked in place with a few finish nails into the window opening. Each of the jambs 102-104 is provided with a full-length rectangular groove or dado 120-122 into which uniform-size plastic zipper ties 130-139 can be inserted and locked. Here, three are shown on each side and four along the header, but the best number of plastic zipper ties to use will vary with the particular window dimensions. The dimensions of the dado 120-122 depend on the uniform dimensions of the zipper ties 130-139. Once a zipper tie is inserted into a dado, it will stay locked and secure against normal separation forces incurred during installation and intended use. In alternative embodiments of the present invention, the dados do not run full-length. Several short ones can be strategically placed to receive the individual zipper ties. However, a single continuous dado is the simplest and least expensive.

The backsides of a left and right casing 140 and 141, and a header or top casing 142 are correspondingly provided with full-length dados. However these are not visible in the views provided in FIGS. 1A and 1B. The relative positions of the corresponding dados from the edges are placed by the factory such that there will be an attractive molding reveal. Such reveal will, by the nature of the construction described herein, be perfectly consistent and uniform with every installation. The installation further includes a bottom apron 144.

FIG. 1B represents a fully assembled kit 100. Such may be glued into the window opening instead of nailed when the jambs, casings, and sill have all been critically configured and sized properly. In alternative embodiments, all the pieces that show after installation may be pre-finished with several coats of special high-durability finishes at the factory before shipment to relieve the installer of the need to paint the finished installation.

FIGS. 1A and 1B did not show how the corner miter joints of side and top casings 140-142 are joined. These joints are especially critical, and how well the joints match up can be the measure of the quality of the installation. Perfect mitered joints are difficult or impossible to obtain by inexperienced and unskilled installers of conventional casings.

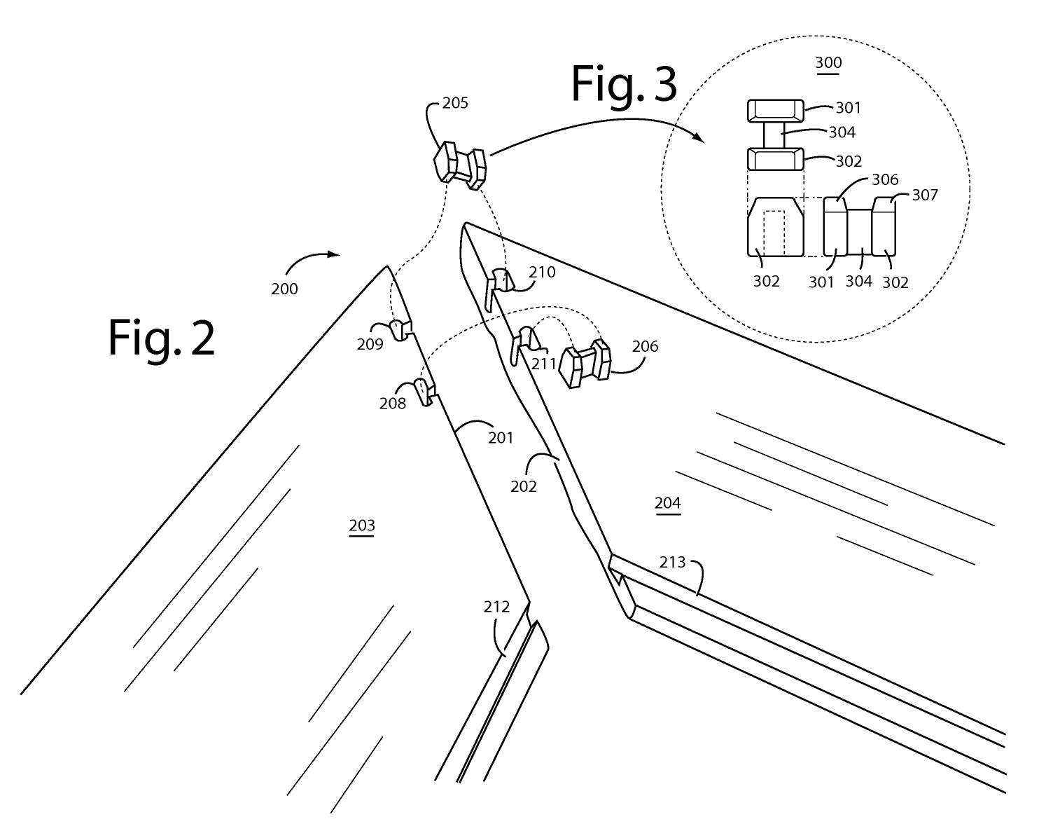

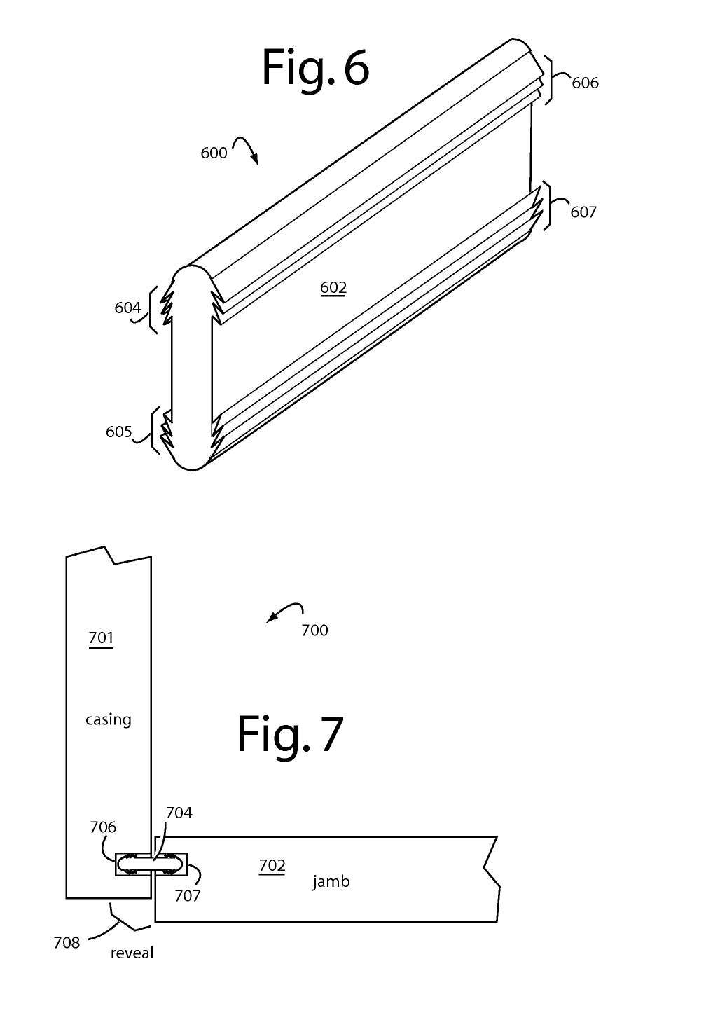

FIG. 2 represents a first type of mitered casing joint, herein referred to by the general reference numeral 200. An H-type joint 200 comprises matching miter ends 201 and 202 on window casings 203 and 204. These are connected together by two H-connectors 205 and 206. Four pockets 208-211 are routed into the mitered ends of casings 203 and 204 at corresponding and matching locations. An installer has only to match up the mitered ends 201 and 202, align routed pockets 208-211, and press in H-connectors 205 and 206. Each window casing 203 and 204 includes a dado 212 and 213 to receive a zipper-tie connector 130-139 for joining to side and top window jambs 102-104. More details on the zipper-tie connectors themselves are provided in FIG. 6. In one prototype embodiment that provided good results, the H-connectors were about ⅜″ wide, ⅜″ tall, and ¼″ thick. The router pockets 208-211 were machined to match.

In FIG. 2 it can be seen that the routed pockets 208-211 are not evenly distributed along the length of mitered edges 201 and 202. This is deliberate. Better results are produced by grouping them nearer the outside corner. Costs can also reduced by being able to use fewer H-connectors.

FIG. 3 provides detailed top, end, and side views of a typical H-connector 300. Two legs 301 and 302 are joined by a crossbar 304. Each leg 301 and 302 has a tapered end 306 and 307 to make insertion into router pockets 208-211 easier for the installer.

In practice, the H-type joint 200 has proven to be relatively expensive to manufacture and softer materials like medium density fiberboard (MDF) cannot be used for the casings. Router pockets machined into MDF break-out too easily.

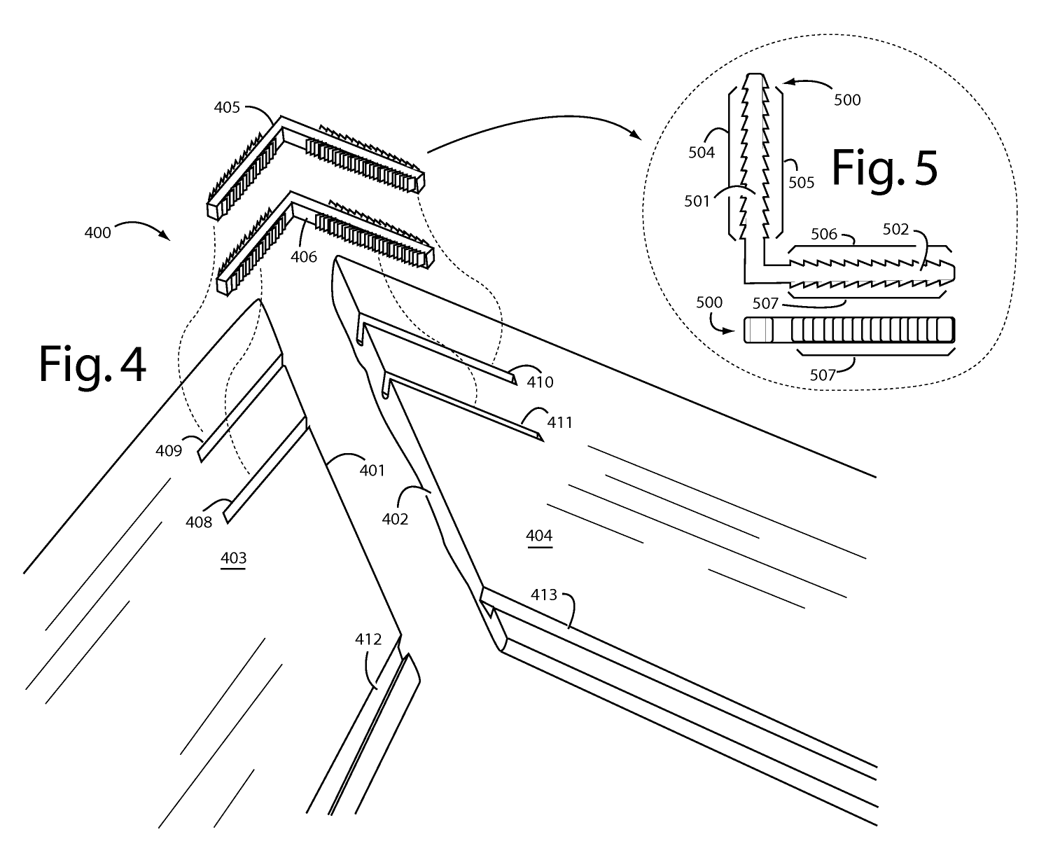

FIG. 4 represents a second type of mitered casing joint, herein referred to by the general reference numeral 400. An L-type joint 400 comprises matching miter ends 401 and 402 on window casings 403 and 404. These are connected together by two ribbed plastic L-connectors 405 and 406. Four dados 408-411 are cut square into the mitered ends of casings 403 and 404 at corresponding and matching locations. An installer has only to match up the mitered ends 401 and 402, align dados 408-411, and press in L-connectors 405 and 406. Each window casing 403 and 404 includes a dado 412 and 413 to receive a zipper-tie connector 130-139 for joining to side and top window jambs 102-104. In one prototype embodiment that provided good results, the L-connectors were about ⅛″ wide, ⅜″ tall, and 1″ long legs. Dados 408-411 were machined to match.

FIG. 5 details a ribbed plastic L-connector 500, as can be used in FIG. 4. Ribbed plastic L-connectors 500 comprise two legs 501 and 502 on which are disposed ribs of feathers 504-507 on their sides. The tops and bottoms of legs 501 and 502 are smooth and straight. In FIG. 5, ribs of feathers 504-507 are shown set 90° to the long edges of legs 501 and 502. There may be an advantage to setting them in at some more acute angle to help dados 408-411 better permanently retain the ribbed plastic L-connectors 500 after assembly and installation.

FIG. 6 represents a zipper-tie 600 in an embodiment of the present invention. Zipper-tie 600 is used to permanently connect jams and casings together as shown in FIGS. 1A, 1B, and 7. Zipper-tie 600 comprises a plastic body 602 with four sets 604-607 of three molded feathers each sized to fit and lock into corresponding dados. In one prototype embodiment that provided good results, zipper-tie 600 was 2⅞″ long, ⅜″ tall, and ⅛″ thick. Zipper-tie 600 can be extruded from molten thermo-plastics.

FIG. 7 represents how zipper-ties 600 are used in the window casing kit 100 (FIG. 1). A casing to jamb joint 700 comprises a window casing 701 joined to a window jamb 702 with one or more zipper-ties 704. these are pressed into corresponding matching dados 706 and 707 respectively cut into the rear face of casing 701 and the long edge of jamb 702. The dados 706 and 707 are positioned parallel to their respective longitudinal edges such that an attractive molding reveal 708 will result after assembly.

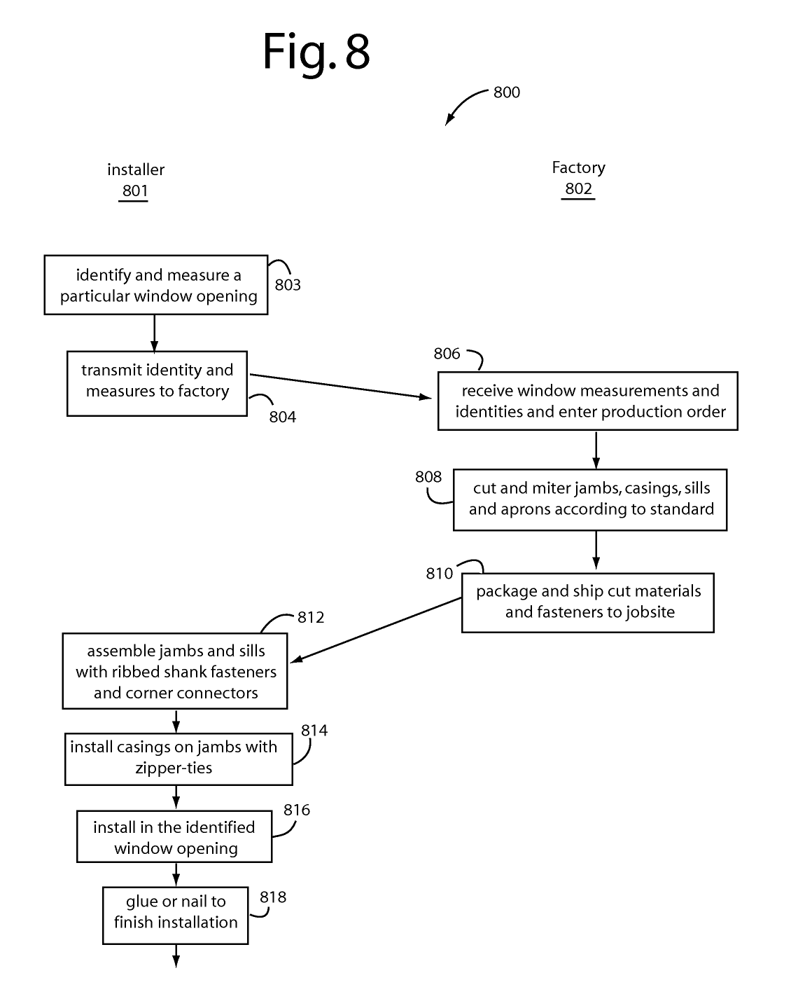

FIG. 8 represents a window casing method 800, in an embodiment of the present invention referred to herein by the general reference numeral 800. An installer 801 and a factory 802 work together to case windows at a particular jobsite. Installer 801 begins with a step 803 in which particular window openings are identified and measured. This data is then transmitted to the factory in a step 804, e.g., using a fax, or website on the Internet maintained by the factory 801. A step 806 receives the data and enters a production order. A step 808 cuts and miters the jambs, casings, sills, and aprons needed for each particular window opening. These are packaged and shipped with the materials and necessary fasteners in a step 810 to the installer and the jobsite. The installer assembles the jambs and sills in a step 812 using the supplied ribbed shank fasteners and corner connectors. The casings are connected to each other using the corner connectors and these are attached to the jambs using the zipper-ties in a step 814. The assembly is then installed in the window opening in a step 816. A step 816 finishes the installation by nailing or gluing the whole assembly into the window opening.

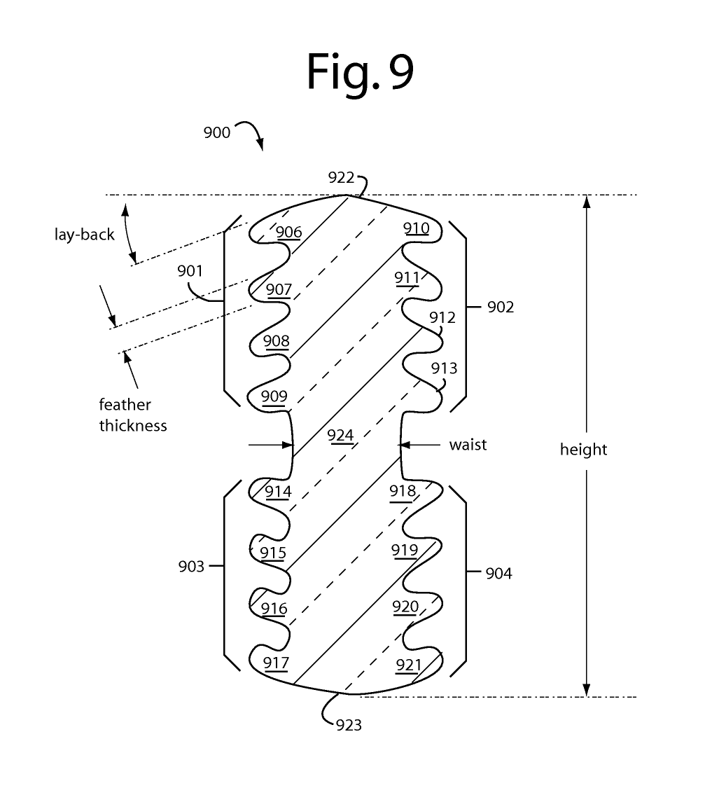

FIG. 9 is a cross-section that represents a second type of zipper-tie 900 in an embodiment of the present invention similar to those shown in FIGS. 1A, 6, and 7. Zipper-tie 900 is molded from a plastic material about 9.700 mm tall, 3.749 mm overall thickness, and 40-50 mm long with four groups 901-904 of feather edges 906-921 lay back at about 20° from a opposite noses 922 and 923 on a main body 924. Main body is narrower at the waist, here about 2.184 mm. Feather edges 906-921 are about 0.5 mm thick with tip and valley radii of 0.254 mm, and a feather-to-feather pitch of about 1.081 mm. Noses 922 and 923 have a radii of about 2.54 mm.

The foregoing dimensions, of course, are merely an example of what has proven to be practical. Other sizes too can work well.

The advantage of zipper-tie 900 over those shown in FIGS. 1A, 6, and 7, is that they insert easier into their corresponding dados without getting twisted-in wrong.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A window casing system in a kit, comprising:
a pair of side window jambs and a top window jamb cut to fit together as a group in a particular window opening;
a pair of side and top window casings with mitered ends and cross-cut to fit said particular window opening and the pair of side window jambs and top window jamb;
a window sill cut to fit said particular window opening and the pair of side window jambs and top window jamb;
a group of drilled holes provided in the ends of the pair of side window jambs and top window jamb for joining them and the sill together with plastic ribbed-shank fasteners;
a first group of dados longitudinally disposed in each front edge of each of the pair of side window jambs and top window jamb;
a second group of dados longitudinally disposed in the rear faces of each of the side and top window casings;
a number of zip-ties sized to press in and lock into corresponding ones of the first and second group of dados;
a set of matching routings disposed on the backsides at said mitered ends of the side and top window casings;
a number of corner-ties sized to press and lock into corresponding ones of the set of matching routings for a tight and well-aligned corner joint;
wherein the first and second groups of dados are relatively disposed to one another such that a uniform molding reveal is created when the jams and casings are joined by the zip-ties.

2. The kit of claim 1, wherein:
the corner ties comprises a H-profile plastic piece and each leg of which presses and locks into a corresponding said routing disposed at said mitered ends of the side and top window casings.

3. The kit of claim 1, wherein:
the corner ties comprises a L-profile plastic piece with ribbed legs that press and lock into a corresponding said routings disposed at said mitered ends of the side and top window casings.

4. The kit of claim 1, wherein:
the jambs, casings, and sill are pre-finished with paint such that painting after the installation of the kit is unnecessary.

5. The kit of claim 1, wherein:
the jambs, casings, and sill are configured and sized such that they may be glued into the particular window opening and not require nailing.

6. A method for casing a window, comprising:
indentifying and measuring particular window openings in a building at a jobsite;
transmitting said window identities and measurements to a factory by electronic means;
entering said window identities and measurements into a production order;
cutting and mitering a set of window jambs, casings, sills, and aprons for each said particular window opening;
packaging and shipping a kit of cut materials including the window jambs, casings, sills, and aprons, and ribbed-shank and corner connector fasteners, and zipper-ties to the jobsite;
assembling the cut window jambs, casings, sills using the supplied ribbed shank fasteners and corner connectors, wherein the casings are connected to each other using the corner connectors and these are attached to the jambs with the zipper-ties that plug into dados; and
installing the assembly in the window opening;
wherein the installation is finished by nailing or gluing the whole assembly into the window opening.
